(19) United States
(12) Patent Application Publication
(10) Pub. No.: US 2024/0398194 A1
(43) Pub. Date: Dec. 5, 2024

(54) METHOD AND DEVICE FOR THE AUTOMATED EMPTYING OF LOOSE TRANSPORT GOODS FROM A CONTAINER

(71) Applicant: ADLATUS Robotics GmbH, Ulm (DE)

(72) Inventors: Christian Häußler, Neu-Ulm (DE); Siegfried Hochdorfer, Untersulmetingen (DE)

(73) Assignee: ADLATUS Robotics GmbH, Ulm (DE)

(21) Appl. No.: 18/678,077

(22) Filed: May 30, 2024

(30) Foreign Application Priority Data
May 31, 2023 (DE) 10 2023 114 348.4

(51) Int. Cl. A47L 11/40

(52) U.S. Cl. CPC A47L 11/4025; A47L 11/4061; A47L 2201/022; A47L 2201/024

(57) ABSTRACT

The invention proposes a method for the automated discharge of loose transport material from a container, transported by means of a self-driving vehicle, into a collection container, where the unloading takes place in a spatially defined unloading cone within an unloading station. Furthermore, an unloading station for automated discharge according to the method is proposed.

The invention relates to a process for the safe and automated emptying of a sweeper container of a cleaning robot in a suitable service station.

The objective of the invention is to provide a process that extends an autonomous cleaning process to also enable the automatic emptying of the cleaning robot's sweeper container. Additionally, it aims to provide a corresponding device.

This objective is achieved by a process for emptying according to the features of claim 1 and a device according to the features of claim 5.

According to the invention, a method is provided that enables the automated emptying of the sweeper container in a service station while mitigating all risks arising from the necessary movements through an inherently safe design and/or suitable technical protective measures to an acceptable level.

The invention introduces a method that, in combination with a device developed for this purpose, allows the overloading of sweepings from a cleaning robot into a collecting container without posing a risk to persons due to the process and the associated movements of the robot and its attached parts.

The method for the automated emptying of loose transport goods from a container, which is transported by means of a self-driving vehicle, into a collecting container, according to claim 1, proposes the following steps:

First, providing a spatially defined unloading zone in an unloading station, which can accommodate the self-driving vehicle on at least one side through separating protective devices and at least partially surrounds it, advantageously providing a front end limitation and side limitations.

Then, in a further step, sensing the unloading zone by means of sensors provided on the self-driving vehicle.

The next step involves evaluating the sensor data to determine the availability situation of the unloading zone and, upon detecting the emptiness of the unloading zone, driving the self-driving vehicle into this zone to a defined position relative to the expected location of the collecting container, with the driving specifically adhering to a predetermined distance from the side walls and the front end wall, thereby enabling defined safety distances.

In the next process step, lifting the container and swiveling it by means of a swiveling device over the collecting container and emptying the container.

Repeatedly sensing the unloading zone during the lifting and emptying process by means of the sensors provided on the self-driving vehicle, and stopping any movement upon detecting a deviation, except for the self-driving vehicle, from the otherwise empty condition of the unloading zone.

Further step: Moving the container back by means of the swiveling device.

According to an advantageous embodiment of the method, it is provided that the container selected is specifically a sweeper container, and the transport goods are specifically loose sweeping materials that have been picked up by the self-driving vehicle, designed as a cleaning robot, in a cleaning process and then transported, with the collecting container specifically chosen as a standardized trash can.

A further preferred process step provides that the sensing of the unloading zone by means of sensors provided on the self-driving vehicle is carried out by at least one side of the unloading station under determination of its line course, specifically by means of 2D laser scanners, wherein the contour of the unloading zone detected by sensing is compared with a stored expected empty contour, and accordingly an availability situation is positively determined if no deviations are present, and specifically, this process is repeated multiple times.

Another no less advantageous process step provides that, in addition to the emptying of the sweeper container, the charging of the cleaning robot's batteries is enabled by a charging device; for this purpose, it is intended to leave the robot in the parking position after emptying the sweeper container, where the charging advantageously takes place.

According to the second aspect of the invention, an unloading station for the automated emptying of loose transport goods from a container of a self-driving vehicle into a collecting container, specifically according to a method of claims 1 to 4, is proposed, characterized in that the self-driving vehicle is a cleaning robot that fills a carried container with sweeping materials in a cleaning process, wherein at the unloading station, the collecting container is held in a defined position, and the cleaning robot can drive up to the collecting container in a spatially defined unloading zone, wherein the defined unloading zone is defined by a surface that is limited on at least one side by separating protective devices, specifically in the form of a fence or a partition, by a front end limitation and side limitations.

The method allows, in another embodiment, to perform both the emptying of the sweeper container and the charging of the cleaning robot's batteries individually and independently of each other. For this purpose, it is intended to leave the robot in the parking position after emptying the sweeper container, where the charging advantageously takes place.

To enable simple emptying of the collecting container in the service station, it is advantageously designed as a standardized trash can.

The sweeper container in the cleaning robot is functionally placed near the ground to facilitate the collection of coarse and fine dirt.

Both the collecting container and the cleaning robot are located at ground level in the service station to minimize the structural measures required for the process's implementation.

The positioning of the collecting container and the sweeper container necessitates lifting the sweeper container to empty its contents into the collecting container.

Specifically, the lifting process poses various risks, as the lifting mechanism inevitably offers several pinch and shear points. Additionally, functional pinch points also arise on the sweeper container, which must be opened for emptying. According to the invention, these risks are sufficiently mitigated by an inherently safe design and/or technical measures.

To mitigate risks, the service station is constructed from multiple protective fence elements or other comparable separating protective devices that prevent interference with the moving parts.

To ensure no persons are present in the service station when the cleaning robot enters, further technical measures are taken to monitor the danger area.

An embodiment of the process provides a clearance between the sides of the cleaning robot and the separating protective devices, ensuring that a person can enter the service station to start the device.

Regardless of the width of the cleaning robot and the associated service station, the invention ensures that there is no risk to persons at any time.

To ensure no objects are present in the service station before the cleaning robot enters, its contour is checked for deviations from a stored model. The process provides for this comparison at several points in time to reliably avoid collisions with non-stationary obstacles.

The contour comparison is performed, for example, with one or more 2D laser scanners that represent the required functions with a sufficiently high performance level.

During the cleaning operation, the cleaning robot uses sensors that, for example, prevent collisions with persons by setting up protective fields. Since the outer contour of the cleaning robot significantly increases during the emptying of the sweeper container and its contour must overlap with that of the collecting container, the inventive process is required to exclude any risk to persons at all times.

The cleaning robot is positioned at a precisely defined position in front of the service station at the start of the process. This position is approached, for example, based on localization data or other features detected by sensors.

Through an inherently safe design, it is ensured that no persons are present in the area where the collecting container is placed. This area is separated from the parking position of the cleaning robot by an additional separating protective device.

Standing in the position in front of the service station, the optical sensors of the cleaning robot can monitor the entire drivable area. By comparing the visible contour of the side and intermediate walls with a previously defined line course, the detection of obstacles within the danger area is conducted. The precision of the robot's positions dictates appropriately large tolerances. These should only be large enough to reliably detect a person regardless of their location.

This information is stored until either the docking process is completed or a violation of the subsequently described contours occurs.

The initial contour comparison with at least one side ensures that no persons are in the danger area before the cleaning robot starts moving. Subsequently, it moves forward or backward into the service station, maintaining a constant distance from the side walls. Their contour continues to be monitored to ensure no persons enter the danger area during the entry into the service station. Monitoring of the intermediate wall is unnecessary as its contour changes relative to the cleaning robot.

For emptying the sweeper container, it is lifted. Especially during this step, contour monitoring ensures that persons cannot access the pinch points in the lifting mechanism by reaching over the monitored areas.

The position of the sweeper container is monitored, for example, by a contact sensor. Alternatively, an encoder can be used for precise detection of its position. Once the sweeper container is in a different position than its starting position, switching to cleaning mode and moving outside the service station is no longer possible. If a malfunction occurs during emptying, it must be resolved manually, for example. Subsequently, the sweeper container can be moved back to the starting position under the supervision of a qualified person.

After the lifting movement, the cleaning robot moves to a position where the sweeper container is above the collecting container for emptying. Upon reaching the position, the contents of the sweeper container are transferred to the collecting container, for example, by opening a flap. After emptying, the sweeper container is reclosed or otherwise prepared for the next filling.

After emptying the sweeper container, the cleaning robot moves to a position further forward in the service station, where the sweeper container can be returned to its starting position. During this step, the contour monitoring of the side walls remains active to exclude any risk to persons.

For all further driving maneuvers, the contour monitoring is deactivated, and the monitoring of the protective fields, as used during the cleaning operation, is reactivated. These fields reliably prevent collisions between the outer contour of the cleaning robot and persons.

Depending on the embodiment of the process, various tasks can be fulfilled after emptying the sweeper container. Another embodiment provides for charging the batteries after emptying. For this purpose, the cleaning robot moves to a position where contacts fixed to it establish a connection with charging electronics installed in the service station. Alternatively, a contactless charging technique can be used, where the batteries are charged inductively.

The movement to the charging position is designed to ensure that the components of the service station do not violate the protective fields. This is advantageous as it eliminates the need to select a special operating mode for the safety control and saves data on previous states.

Advantageously, there is also the option to switch off several or all components of the cleaning robot during the charging process to reduce its energy consumption. At this point, the process does not require continuous monitoring of contours or protective fields, as no movement occurs. Therefore, storing information about their status, which may not be available after switching off components, is unnecessary.

After the charging process is completed or a cleaning task is requested, the cleaning robot can be manually and/or automatically switched on again. It then leaves the service station while maintaining all protective measures that also exist during cleaning operation.

Another embodiment provides for the direct start of a cleaning program after emptying the sweeper container. For this, the cleaning robot leaves the service station and executes a predetermined cleaning task. In this case, protective measures different from those during the cleaning operation are required.

During all steps, the position of the cleaning robot is determined relative to the service station, for example, by the Iterative Closest Point Algorithm, and the driving maneuvers are adjusted accordingly to reach all target positions.

To ensure a correspondingly high availability of all safety systems in the event of a malfunction, the monitoring of all contour and protective field monitoring can be outsourced to a separate control unit. This unit receives information about the requested movements from the main computer of the cleaning robot and can safely shut them down at any time. All localization and kinematic calculations are functionally performed on a main computer, whose failure probability can be higher than that of the safety-oriented control unit.

Further advantageous embodiments result from the further dependent claims or their possible sub-combinations.

The invention will be further explained below with reference to the drawings. Specifically, the schematic representation shows:

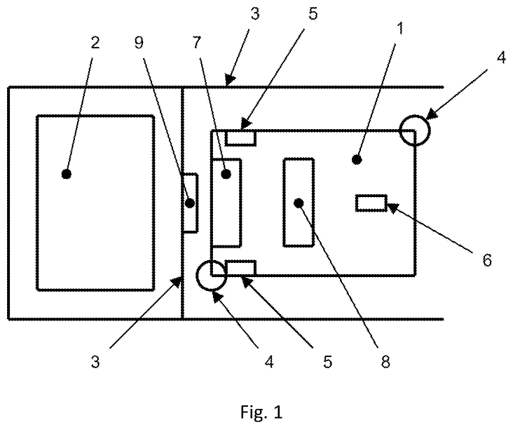

FIG. 1: a schematic representation of a cleaning robot in a service station,

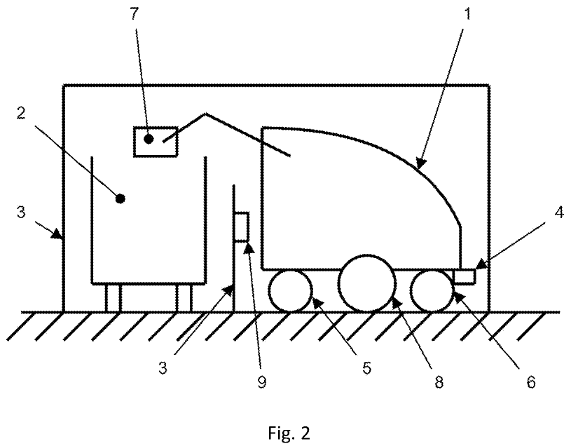

FIG. 2: a schematic representation of a cleaning robot with a raised sweeping container in a service station,

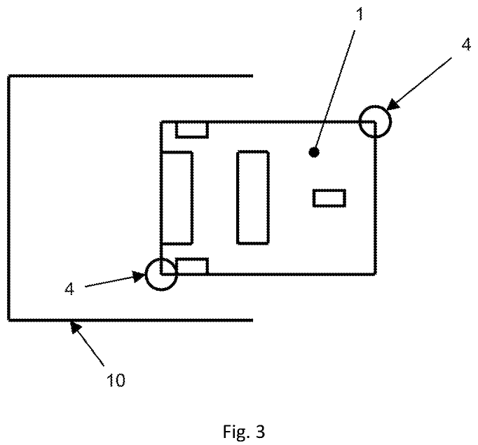

FIG. 3: a schematic representation of the contour 1 to be monitored,

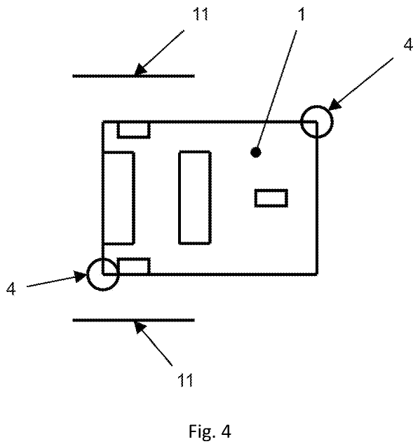

FIG. 4: a schematic representation of the contour 2 to be monitored,

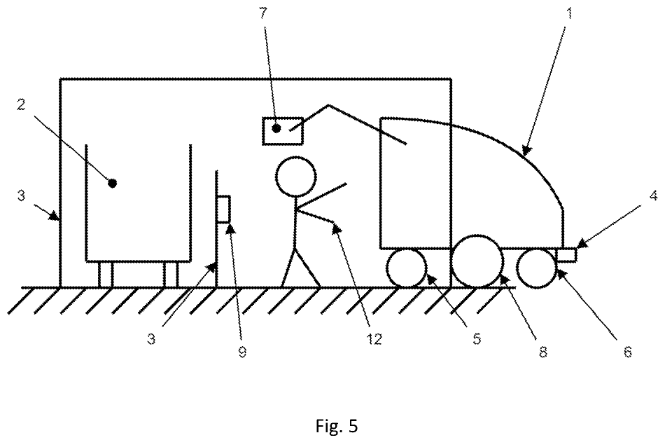

FIG. 5: a schematic representation of a person in the danger zone after the sweeping container has been raised,

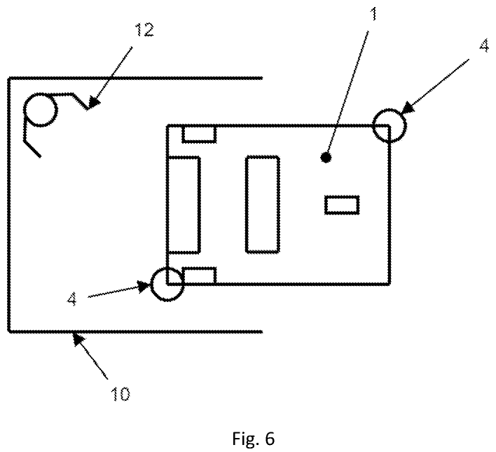

FIG. 6: a schematic representation of a person in the danger zone before the sweeping container has been raised,

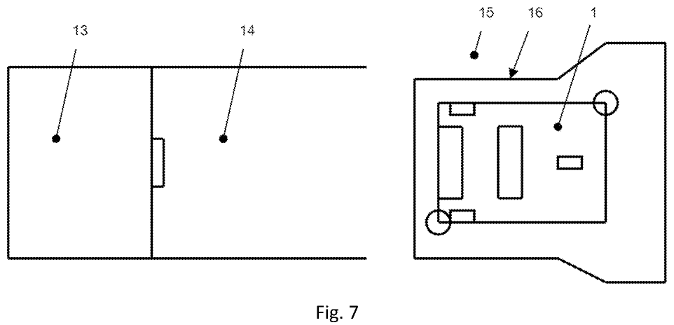

FIG. 7: a schematic representation of the three areas in which the robot operates during its operations.

The same reference numerals in the figures refer to the same or similarly acting elements.

FIG. 1 shows a schematic representation of a top view of a possible embodiment of the service station required for the implementation of the inventive process together with a cleaning robot 1 placed in it. This is a sweeping robot, which, in addition to two free-wheeling wheels 5, has a driven and steered wheel 6. The collected dirt is transported by the sweeping brush 8 into the sweeping container 7. For securing the danger area, two laser scanners 4 are exemplarily mounted.

FIG. 2 shows a side view of a cleaning robot 1 in a service station at the time of emptying the sweeping container into the collection container. The service station is constructed with several separating safety devices 3 and includes a collection container 2 as well as the necessary charging technology 9.

FIG. 3 shows the contour 10 to be detected by the optical sensors before the movement of the sweeping container, ensuring that no persons are within the danger zone of the service station before the movement of the sweeping container is started. This is monitored by the laser scanners 4.

FIG. 4 shows the contour 2 (11) to be monitored after checking contour 1 (10). By monitoring this contour, it can be ensured during the lifting of the sweeping container and during the movement of the cleaning robot with the raised sweeping container into the service station that all movements are immediately stopped if a person enters the danger zone.

FIG. 5 shows a person 12 who has entered the danger zone of the service station after the sweeping container 7 has been raised. There is a risk of pinching between the collection container 2 and the robot when the robot is reversed.

FIG. 6 shows a person 12 who has entered the danger zone of the service station before the sweeping container 7 has been raised. There is a risk that limbs could be pinched in the lifting mechanism when the sweeping container 7 is raised.

FIG. 7 shows the three areas in which the robot operates during its operations. In the rear area 13, the collection container 2 is placed. In the front area 14, the robot moves during the lifting and lowering of the sweeping container 7. In the free space 15, the safety of persons is ensured by safety fields 16.

### Detailed Process Description

The service station can be divided into several areas. In the rear area 13, the collection container is placed. This could be, for example, a waste container according to DIN EN 840-2 with a volume of 1100 liters. This area is completely surrounded by protective fences or similar separating safety devices. Structural measures ensure that no person can be present in the area where the waste container is to be placed. Since the robot must move the sweeping container over the collection container to empty it, sensors cannot ensure that no person is pinched. For example, a person could be at the position of the waste container or inside it. There are no sensors available that can reliably distinguish a person from another object.

In the context of the Machinery Directive 2006/42/EC, “safe” refers to a device that poses no danger in regular use and with reasonably foreseeable misuse. During the process of emptying the sweeping container, particularly mechanical hazards from open, moving parts occur. The risk of injury to persons from these hazards is minimized by the described procedures and devices to the extent that the machine is considered safe.

In this case, a mechanical device ensures that no person can be in the area of the waste container without the contour of the service station deviating from a preset standard. If deviations are present, no dangerous movements such as lifting the sweeping container are performed, and the robot remains in a safe state.

During the cleaning operation in the free space 15, the robot uses safety fields 16 to reliably prevent collisions with persons. These are two-dimensional areas monitored relative to the robot by laser sensors. Their size depends on the current travel speed and is determined by the stopping distance of the robot in the event of an emergency stop triggered by a violation of the safety field. The safety laser scanners used must reliably detect persons within the safety field. This is implemented with the performance level d specified by the manufacturer according to ISO 13840.

Monitoring the entire danger zone during the emptying of the sweeping container with sensors mounted on the robot is not possible for various reasons. The base area of the robot projected onto the scan plane of the safety laser scanners increases significantly during the lifting of the sweeping container. This base area is at a height of 18 cm. Additionally, it must be assumed that persons may reach over the safety field, which would require enlarging the safety field further. This results in a particularly large danger zone that must remain completely free throughout the entire unloading process. This would mean that a large area around the waste container would have to be cordoned off.

Furthermore, during the movement of the sweeping container over the collection container, the contour of the robot projected onto the scan plane overlaps with the contour of the waste container. Therefore, sufficient risk reduction cannot be achieved by using safety fields.

Additionally, the waste container obscures the area behind it, so sensors mounted on the robot cannot ensure that there is no person behind the container who could reach into the moving parts of the sweeping container from their position and get injured.

By means of a mechanism built into the separation of the waste container, the container can be removed for emptying. At the same time, it is ensured that the contour of the service station is sufficiently altered while the separation is open so that the safety sensors on the robot detect that not all conditions for performing a safe unloading process are met. The separation can only be closed if the operator is outside the separated area 13, ensuring that no person is in the described danger zone when the separation is closed.

In addition to the mechanical separation of area 13, where the waste container is located, sensors can also ensure that no person is in this danger zone. For example, it would be conceivable to detect the contour of the waste container by laser scanners installed in the station or to identify the container using RFID technology. However, these solutions always require control technology within the service station and secure communication between the service station and the robot. A mechanical separation is simple and inexpensive to implement and provides very good protection. Moreover, in the chosen variant, no communication between the components of the service station and the robot is necessary. If safety functions are performed by electronic components installed in the station, the data read by these components must be transmitted to the robot on a secure channel. This represents an additional economic factor.

Another area of the service station is area 14, where the robot is located during the unloading and loading process. This area is bounded on two sides by protective fences and on one side by the separation to the waste container. A particular danger here during the lifting and lowering of the sweeping container comes from the required mechanics, which provide several pinch points that cannot be covered due to their function. Due to the high weight of the sweeping container, very strong actuators are used. These are hydraulically actuated cylinders, although electric drives could fulfill the same purpose. Compared to the forces needed to lift the container, the forces occurring from pinching limbs would be relatively low and difficult to detect. The separating safety devices that delimit this area 14 are designed to be detected by the laser scanners. The protective fences used are equipped with metal plates mounted at the height of the scanning plane of the laser sensors. All three separations form a U-shape. The presence of these is checked before initiating dangerous movements using contour monitoring of the safety laser scanners. It is ensured with the performance level d specified by the manufacturer according to ISO 13849 that the contour detected by the laser scanner is within a defined range relative to a specified contour. This range is chosen so small that no person can be within the separations without violating the monitored contour.

After ensuring that no person is within area 14 where the robot operates, movements with increased potential hazards are initiated. Since the position of the separation between the robot and the waste container changes relative to the robot during the travel movements, contour monitoring to this separation is no longer possible after the movement is initiated. From this point on, only the contour of the two side walls is monitored. Since it was previously ensured that no person is in the entire area 14, it is sufficient to monitor the remaining accesses between the robot and the protective fence. If a person enters the danger zone, they violate the contour of the side wall and cause the robot to immediately enter a safe operating state. In this state, all actuators are de-energized, and no movement is possible.

This state can only be reset by a trained operator who manually returns the robot to a safe state.

If an operator intervention on the robot is required, for example, to perform actions on the control panel, where the service station is designed so that no person can move between the robot and the protective fence, an opening in the form of a door or flap would need to be added. Since people could reach the danger zone wholly or partially through this opening, it must be designed so that it violates the monitored contour in such a way that the robot stops all dangerous movements and enters a safe state when open. This could be achieved by a door that reaches the floor and structurally violates the contour of the service station. Alternatively, a small flap could be complemented by components that cause a corresponding contour change by swinging out after opening. Monitoring the opening with special sensors installed in the station would require transmitting safety-related information between the station and the robot.

### LIST OF REFERENCE NUMBERS

1 Cleaning robot
2 Collection container
3 Separating safety device
4 Optical sensors
5 Free-wheeling wheels
6 Steered drive wheel
7 Sweeping container
8 Cleaning unit
9 Charging technology
10 Contour 1
11 Contour 2
12 Person in the danger zone
13 Area 1
14 Area 2
15 Area 3/free space
16 Safety field

1. Method for the automated emptying of loose transport goods from a container, which is transported by means of a self-driving vehicle, into a collecting container,
characterized by the steps:
Providing a spatially defined unloading zone in an unloading station, which can accommodate the self-driving vehicle on at least one side through separating protective devices and at least partially surrounds it,
Sensing the unloading zone by means of sensors provided on the self-driving vehicle,
Evaluating the sensor data to determine an availability situation of the unloading zone and, upon detecting the emptiness of the unloading zone, driving the self-driving vehicle into this zone to a defined position relative to the expected location of the collecting container,
Lifting the container and swiveling it by means of a swiveling device over the collecting container and emptying the container,
Repeatedly sensing the unloading zone during the lifting and emptying process by means of the sensors provided on the self-driving vehicle, and stopping any movement upon detecting a deviation, except for the self-driving vehicle, from the otherwise empty condition of the unloading zone,
Moving the container back by means of the swiveling device.

2. Method according to claim 1,
wherein
the container selected is specifically a sweeper container and the transport goods are specifically loose sweeping materials that have been picked up by the self-driving vehicle, which is designed as a cleaning robot, in a cleaning process and then transported.

3. Method according to claim 1,
wherein
the sensing of the unloading zone by means of sensors provided on the self-driving vehicle is carried out by at least one side of the unloading station under determination of its line course, specifically by means of 2D laser scanners,
here, the contour of the unloading zone detected by sensing is compared with a stored expected empty contour, and accordingly an availability situation is positively determined if no deviations are present,
specifically, this process is repeated multiple times.

4. Method according to claim 1,
wherein
in addition to the emptying of the sweeper container, the charging of the cleaning robot's batteries is enabled by a charging device; for this purpose, it is intended to leave the robot in the parking position after emptying the sweeper container, where the charging advantageously takes place.

5. Unloading station for the automated emptying of loose transport goods from a container of a self-driving vehicle into a collecting container, specifically according to a method of claim 1,
wherein
the self-driving vehicle is a cleaning robot that fills a carried container with sweeping materials in a cleaning process,
wherein at the unloading station the collecting container is held in a defined position, and the cleaning robot can drive up to the collecting container in a spatially defined unloading zone,
wherein the defined unloading zone is defined by a surface that is limited on at least one side by separating protective devices, specifically in the form of a fence or a partition, by a front end limitation and side limitations.
